(19) United States
(12) Patent Application Publication
(10) Pub. No.: US 2024/0241244 A1
(43) Pub. Date: Jul. 18, 2024

(54) METHOD AND DEVICE FOR RADAR TARGET FEATURE RECOGNITION BASED ON OPTICAL TIME-DELAY FAST INTERFEROMETRIC SCANNING

(71) Applicant: Zhejiang University, Hangzhou (CN)

(72) Inventors: Xiaofeng JIN, Hangzhou (CN); Jie LI, Hangzhou (CN); Yafeng ZHU, Hangzhou (CN); Bing WEI, Hangzhou (CN); Xiaohuan SUN, Hangzhou (CN); Yinfang XIE, Hangzhou (CN)

(21) Appl. No.: 18/155,750

(22) Filed: Jan. 18, 2023

(51) Int. Cl. G01S 13/44; G01S 7/41

(52) U.S. Cl. CPC G01S 13/4409; G01S 7/412; G01S 13/4454

(57) ABSTRACT

A device for radar target feature recognition based on optical time-delay fast interference scanning. The device includes an antenna unit, an electro-optical converter, an optical time-delay numerical control scanning device, an optical combiner, a photoelectric detector and a power characteristic analysis device. The device quickly scans the delay amount of the two signals through the optical delay line, and calculates the power of the combined signal through photoelectric conversion and linear power detection. By observing the relationship between the combined power and the delay time, the rapid identification of the target radar signal characteristics is realized.

### FIELD OF THE DISCLOSURE

The disclosure belongs to the field of optoelectronic technology, and in particular relates to a method and a device for radar target feature recognition based on optical time-delay fast interference scanning.

### BACKGROUND OF THE DISCLOSURE

With the development of electronic technology in military applications, electronic countermeasures have gradually become active in the arena of modern warfare as a means of combat that is directly used for offense and defense. The basic means of electronic countermeasures are electronic reconnaissance, jamming and destruction. Among them, electronic reconnaissance is mainly realized through radar detection technology. Radar achieves rapid identification of targets by analyzing the received electromagnetic waves. In recent years, for the purpose of anti-reconnaissance and anti-jamming, the modulation pattern and modulation parameters of radar signals have the characteristics of time-varying, fast and wide range, which brings great difficulties to the reconnaissance and identification of electronic countermeasures.

In order to adapt to different combat conditions, researchers continue to explore methods for quickly and accurately identifying the azimuth and spectrum characteristics of radar targets. Multi-beam direction finding and interferometer direction finding are the two most widely used direction finding techniques at present. Multi-beam ratio amplitude direction finding is to determine the angle of arrival of the signal by using the relative amplitude of the signal received by the adjacent beams of the main lobe, but this method has higher requirements on the beams. In order to prevent the non-linearity of the sidelobe ratio curve of adjacent beams, it is necessary to ensure that the two beams are close enough so that the gain of the coverage point of the adjacent beam is higher than the highest sidelobe of the two beams, or the design of the beam width and beam position can be configured to eliminate the effect of side lobes. At the same time, as the frequency of the received signal changes, the angle of the antenna beam axis will deviate, resulting in a change in the angle corresponding to the maximum beam value. The principle of interferometer direction finding is to use the relationship between the distance difference of the signal reaching the two antennas and the angle of arrival of the signal, identify the phase difference of the two received signals through the phase detector, and calculate the angle of arrival of the signal. Compared with multi-beam ratio-amplitude direction finding, although this method has a simple structure and does not need to consider complex beam design, there are problems of mirror ambiguity and phase ambiguity, and the measured phase difference can only be within the range of ±π. Any results beyond the phase measurement range will be unreliable. For the problem of mirror blur, two non-parallel baselines can be configured to eliminate the influence of symmetrical incoming waves on both sides of the two single baselines. For the problem of phase ambiguity, the method of long and short baselines can be used. The short baseline ensures a large angle measurement range, and the long baseline ensures high angle measurement accuracy. Although researchers have made many optimizations and designs to improve the direction-finding accuracy and detection range of the two methods, both the multi-beam ratio method and the interferometer method are only aimed at estimating the target azimuth.

### SUMMARY OF THE DISCLOSURE

Radar radiation sources with various electromagnetic environments and systems require a method that can both detect target orientation and identify target features. Therefore, it is one object of the present disclosure to explore a method that can simultaneously measure the azimuth and spectrum characteristics of radar targets.

In view of the above, the present disclosure provides a method and a device for radar target feature recognition based on optical time-delay fast interference scanning.

A method and a device for radar target feature recognition based on optical time-delay fast interference scanning are provided. The device comprises an antenna unit, an electro-optical converter, an optical time-delay numerical control scanning device, an optical combiner, a photoelectric detector and a power characteristic analysis device. The antenna unit is configured to receive radar target electrical signals. The electro-optical converter is configured to convert electrical signals into optical signals. The optical delay numerical control scanning device is configured to control the delay amount of the optical signal. The optical combiner is configured to synthesize the optical signal. The photodetector is configured to convert optical signals into radio frequency signals. The power characteristic analysis device is used for calculating the average power of the radio frequency signal and analyzing the characteristics of the radar target. Through the forward scanning and reverse scanning of the optical time-delay numerical control scanning device, the characteristics of the radar target signal are realized according to the power characteristic analysis device.

The antenna unit includes, but is not limited to, a multi-beam reflector antenna, a multi-beam lens antenna and a multi-beam phased array antenna. The antenna unit has a plurality of antenna sub-arrays, each antenna sub-array corresponds to an input channel. The baseline length of two adjacent antenna sub-arrays is L, the angle of arrival of the electrical signal is 0, the frequency is f, and the wave velocity is c. The delay difference between the two adjacent antenna sub-arrays receiving the same electrical signal is ΔT=L sin θ/c, and the phase difference is Δφ=2πfΔT.

The optical delay numerical control scanning device includes a N-stage high-speed optical delay line and an optical delay line controller.

Furthermore, the N-stage high-speed optical delay line is divided into two paths, T1 and T2, which respectively correspond to two input channels of adjacent antenna sub-arrays in the antenna unit. The N-stage high-speed optical delay line includes 2N 1×2 high-speed optical switches. According to the connection mode of 1×2 to 2×1, two high-speed optical switches form a first-stage delay unit, and therefore a total of N-stage delay units is formed. The delay amount of each stage of delay unit is constant, and it is twice the delay amount of the previous stage of delay unit. The delay amount of the first-stage delay unit is Δt. The delay amount of the i-th-stage delay unit is 2ⁱ⁻¹×Δt, where i is a value selected from the range of 1-N. The high-speed optical switch includes, but is not limited to, a magnetic optical switch, an electro-optical switch, a PLZT optical switch, and the like.

Furthermore, the optical delay line controller is configured to change the delay amount of the N-stage high-speed optical delay line that being divided into the path T1 and the path T2. The optical delay line controller changes the delay amount of the i-th stage delay unit through a 1 bit state: 0 means that the delay amount is 0, and 1 means that the delay amount is 2ⁱ⁻¹×Δt. By controlling N delay units through N bits state, the delay amount of a single-path N-stage high-speed optical delay line can be changed in the range of (0−(2^{N}−1))×Δt, and its resolution is Δt.

Furthermore, the optical delay numerical control scanning device realizes forward scanning by fixing the delay amount of the path T2 to 0 and changing the delay amount of the path T1 in the range of (0−(2^{N}−1))×Δt. The reverse scanning is realized by fixing the delay amount of the path T1 to 0 and changing the delay amount of the path T2 in the range of (0−(2^{N}−1))×Δt. The optical time-delay numerical control scanning device changes the time delay within the range of (−(1−2^{N})−(2^{N}−1))×Δt through forward scanning and reverse scanning.

Furthermore, different wavelengths λ1 and λ2 are respectively applied in the two paths (T1, T2) of the N-stage high-speed optical delay line. The optical combiner combines the two paths of light into one optical fiber by means of wavelength division multiplexing. The radio frequency power is obtained by the photodetector.

The electro-optic converter converts the electrical signal into an optical signal, and after passing through the optical delay numerical control scanning device, the phase difference between the two paths is:

$$Δ Φ ( {T}_{d} ) = Δφ - 2 π {fT}_{d} \qquad ( 1 )$$

The power characteristic analysis device includes a linear power detector, an analog-to-digital converter, a processor, and a memory. The linear power detector is configured to calculate the average power of the radio frequency signal after the photodetection. The analog-to-digital converter is configured to quantize the average power converted by the linear power detector. The memory is used for storing the power value P quantized by the analog-to-digital converter. The processor obtains the characteristics of the radar target according to the variation law of the power value P.

The power value P is:

$$P = f \cdot {\int }_{0}^{\frac{1}{f}} {A}^{2} \cdot {[ cos ( 2 π ft ) + cos ( 2 π ft + ΔΦ ( {T}_{d} ) ) ]}^{2} dt \qquad ( 2 )$$

Further simplification (2):

$$P ( A , {T}_{d} ) = {A}^{2} \cdot 4 {cos}^{2} ( \frac{Δ Φ ( {T}_{d} )}{2} ) \qquad ( 3 )$$

For single-frequency signals, A is the amplitude constant, f is the signal frequency, and the combined power is:

$$P ( {T}_{d} ) = {A}^{2} \cdot 4 {cos}^{2} ( \frac{Δφ - 2 π f \cdot {T}_{d}}{2} ) \qquad ( 4 )$$

Further, according to formula (4), the delay corresponding to the power peak is:

$${T}_{k} = ( \frac{Δφ}{2 π f} + \frac{k}{f} ) , k ∈ N \qquad ( 5 )$$

According to formula (4) and formula (5), the power changes periodically with the delay amount, Tx is the delay amount corresponding to the power peak value, and the frequency of the single-frequency signal is estimated by the delay amount interval of the power peak value:

$$\hat{f} = \frac{1}{{T}_{k + 1} - {T}_{k}} \qquad ( 6 )$$

When |Δφ|≤π, that is, when there is no phase ambiguity, according to formula (5), the signal arrival angle is estimated by the position T₀ of the first power peak point:

$$\hat{θ} = arcsin ( \frac{{cT}_{0}}{L} ) \qquad ( 7 )$$

For any broadband signal, the carrier frequency is f_{c}, the baseband signal is A(t), and the combined power is:

$$P ( A ( t ) , Td ) = {p}_{A} ( A ( t ) , Td ) \cdot 4 {cos}^{2} ( \frac{Δφ - 2 π {f}_{c} \cdot {T}_{d}}{2} ) \qquad ( 8 )$$

$${p}_{A} ( A ( t ) , {T}_{d} ) = {E [ A ( t ) + A ( t + Δ T + {T}_{d} ) ]}^{2} \qquad ( 9 )$$

According to formula (5), the power changes periodically with the delay amount, Tx is the delay amount corresponding to the power peak value, and the broadband signal carrier frequency is estimated by the delay amount interval of the power peak value:

$$\hat{{f}_{c}} = \frac{1}{{T}_{k + 1} - {T}_{k}} \qquad ( 10 )$$

Further, formula (9) represents the power envelope curve, which is further simplified as:

$${E [ A ( t ) + A ( t + Δ T + {T}_{d} ) ]}^{2} = {E [ A ( t ) ]}^{2} + {E [ A ( t + Δ T + {T}_{d} ) ]}^{2} + 2 {E [ {R}_{A} ( Δ T + {T}_{d} ) ]}^{2} \qquad ( 11 )$$

Further, the power is normalized according to the maximum value; the envelope of the power is obtained through a digital low-pass filter. As in formula (12), the relative value 1 is the maximum power, and the corresponding delay is Tᵣ_{₁}. According to formula (13), the relative value of 0.5 is the minimum power. The corresponding delay is T_{r0.5};

$$max \{ {E [ A ( t ) + A ( t + Δ T + {T}_{d} ) ]}^{2} \} = 4 {E [ A ( t ) ]}^{2} \qquad ( 12 )$$

$$min \{ {E [ A ( t ) + A ( t + Δ T + {T}_{d} ) ]}^{2} \} = 2 {E [ A ( t ) ]}^{2} \qquad ( 13 )$$

Since the power peak envelope is affected by the components represented by formula (9), the maximum power only appears at the position where the delay difference between the two paths is 0, so there is no phase ambiguity problem in broadband signal detection, and the arrival angel of the signal can be estimated by the delay amount Tᵣ_{₁} corresponding to the maximum power peak:

$$\hat{θ} = arcsin ( \frac{{cT}_{{r}_{1}}}{L} ) \qquad ( 14 )$$

When the signal bandwidth is relatively small, the slope change at the maximum power point is not obvious, taking the intermediate value of two delay amounts Tₓ₁ and Tₓ₂ at the far end of the envelope curve to estimate Tᵣ_{₁}:

$$= {T}_{x 1} + {T}_{x 2} \qquad ( 15 )$$

Furthermore, according to the characteristics of weak power components outside the signal bandwidth, taking Tᵣ_{_{0.5}} which is closest to the center Tᵣ₁ on the power envelope to estimate the bandwidth of the signal:

$$\hat{B} = \frac{1}{min \vert {T}_{{r}_{1}} - {T}_{{r}_{0.5}} \vert} \qquad ( 16 )$$

The method for radar target feature recognition based on optical time-delay fast interferometric scanning is to change the delay amount of the two paths T1 and T2 through the optical delay numerical control scanning device. By observing the pattern of power variation with the delay amounts after the synthesis of the two paths, the rapid analysis of the spectrum characteristics and angle of arrival of the radar target signal can be realized. The frequency of the single-frequency signal is obtained through the interval of the delay amount of the power peak, and the angle of arrival of the signal is obtained through the delay amount corresponding to the first peak point. The carrier frequency of the wideband signal is obtained by the delay interval of the power peak. The angle of arrival of the signal is estimated by the delay corresponding to the maximum power. The spectral bandwidth of the broadband signal is estimated by the delay span of the main lobe of the power peak envelope. Compared with the traditional radar target detection technology, the present method can be used not only to measure the azimuth of the signal, but also to measure the spectral characteristics of the signal. Therefore, the device of the present invention is applicable to the detection of radar targets with different modulation systems in different electromagnetic environments.

### BRIEF DESCRIPTION OF DRAWINGS

FIG. 1 is a schematic diagram of the device according to the present disclosure.

FIG. 2A is a power change diagram of the single-frequency signal on the path T1.

FIG. 2B is a power change diagram of the single-frequency signal on the path T2.

FIG. 3A is the spectrum diagram of QPSK signal.

FIG. 3B is a power change diagram of the QPSK signal on the path T1.

FIG. 3C is a power change diagram of the QPSK signal on the path T2.

### DETAILED DESCRIPTION OF THE DISCLOSURE

In order to describe the present invention more specifically, the technical solutions of the present invention will be described in detail below in conjunction with the accompanying drawings and specific embodiments.

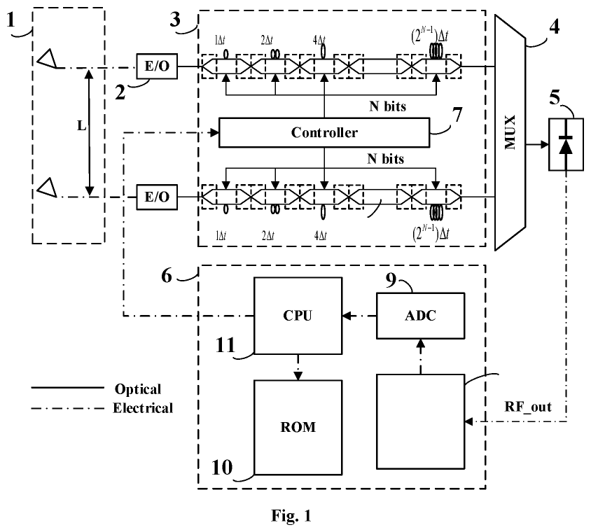

As shown in FIG. 1, a device for radar target feature recognition based on optical time-delay fast interference scanning includes an antenna unit 1, an electro-optical converter 2, an optical time-delay numerical control scanning device 3, an optical combiner 4, a photoelectric detector 5, and a power characteristic analyzing device 6. The optical delay numerical control scanning device 3 includes a two-path N-stage high-speed optical delay line 7 and an optical delay line controller 8. The power characteristic analysis device 6 includes an analog-to-digital converter 9, a memory 10, a processor 11, a linear power detector 12.

The antenna unit 1 is connected to the electro-optical converter 2 through a radio frequency line. The electro-optic converter 2, the optical time-delay numerical control scanning device 3, the optical combiner 4, and the photoelectric detector 5 are sequentially connected through optical fibers. The photodetector 5 is connected to the power characteristic analysis device 6 through a radio frequency line. Inside the optical delay numerical control scanning device 3, the optical delay line controller 8 controls the two-path N-stage high-speed optical delay line 7 through two data buses with N bits width. The power characteristic analysis device 6 sends scanning control instructions to the optical delay line controller 8 through the control bus.

In this embodiment, the N-stage high-speed optical delay line 7 is divided into two paths, T1 and T2. The paths T1 and T2 correspond to two input channels of adjacent antenna sub-arrays in antenna unit 1, respectively. Each of the paths T1 and T2 includes 2N 1×2 high-speed optical switches. According to the connection mode of 1×2 to 2×1, two high-speed optical switches form a first-stage delay unit, and therefore a total of N-stage delay units are obtained. The delay amount of each stage of delay unit is constant, and it is twice the delay amount of the previous stage of delay unit. The delay amount of the first-stage delay unit is Δt, the delay amount of the i-th stage delay unit is 2ⁱ⁻¹×Δt, where i is in the range of 1-N. The processor 11 sends an optical delay scanning control instruction to the optical delay line controller 8. The optical delay line controller 8 changes the delay amount of the i-th stage delay unit through a 1-bit state: 0 means that the delay amount is 0, and 1 means that the delay amount is 2ⁱ⁻¹×Δt. The N delay units are controlled by the N bits state to realize that the delay amount of a single-path N-stage high-speed optical delay line changes in the range of (0−(2^{N}−1))×Δt, and its resolution is Δt. Different wavelengths 21 and 22 are applied on the path T1 and the path T2, respectively. The optical combiner 4 synthesizes the two optical signals with different wavelengths into one optical signal by means of wavelength division multiplexing, and converts the optical signal into a radio frequency signal through the photodetector 5. Inside the power characteristic analysis device 6, the linear power detector 12 is configured to calculate the power of the radio frequency signal. The analog-to-digital converter 9 quantizes the power and sends it to the processor 11 through the data bus. The processor 11 places the quantized data in the memory 10 through the data bus and the address bus. The processor obtains the characteristics of the target signal according to the change rule of the power value with the delay amount.

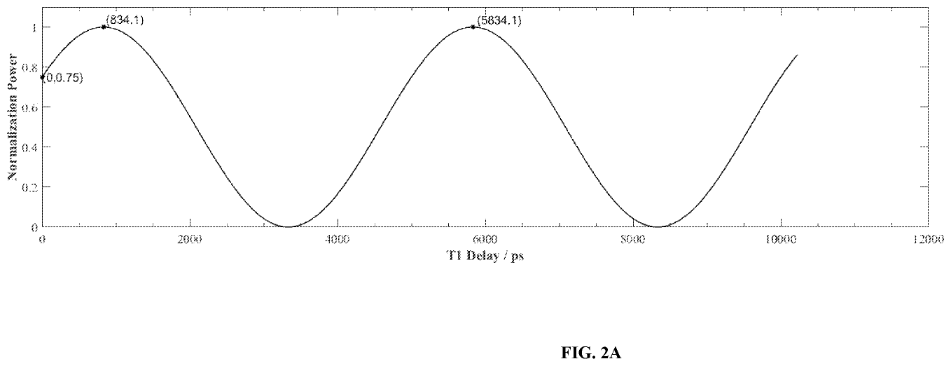

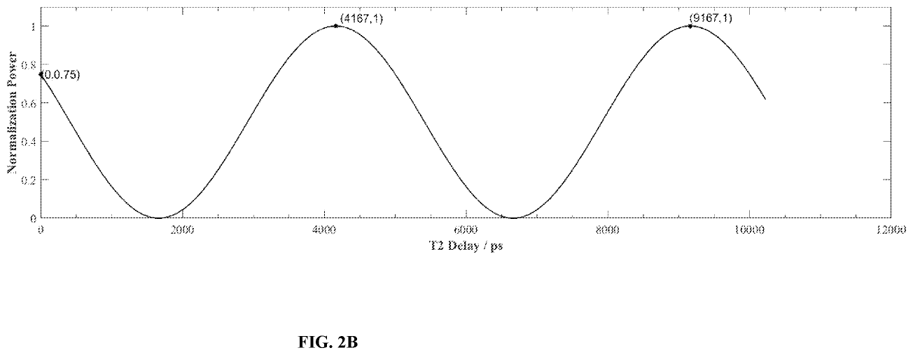

In this embodiment, in order to specify the method of using the device for radar target feature recognition, test results of delay scanning of a single-frequency signal are illustrated. When the baseline length L of the two antenna sub-array channels is 0.5 m, the target signal frequency is 200 MHz, and the signal arrival angle is 30°, the delay difference between the two channels is about 833.3 ps. As shown in FIG. 2a, the optical delay of the path T2 is fixed at 0, and the optical delay of the path T1 is scanned in the range of 0-10230 ps. As shown in FIG. 2A, the delay amount of the first power peak is 834 ps. According to formula (7), the arrival angle of the signal is arcsin(0.5004)≈30°. The delay amount of the second power peak is 5834 ps, which is spaced to the first power peak is 5 ns. According to formula (6), the frequency of the signal is calculated to be 200 MHz. As shown in FIG. 2B, the optical delay of the path T1 is fixed at 0, and the optical delay of the path T2 is scanned in the range of 0-10230 ps. As shown in FIG. 2B, the first power peak is −4167 ps (relative to the path T1). Similarly, an interval of the delay amount of the first power peak in FIG. 2B to the first power peak in FIG. 2A is 5 ns, which coincides with the target signal period.

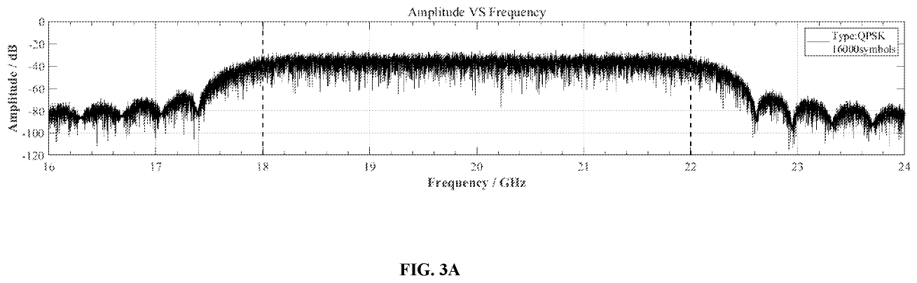

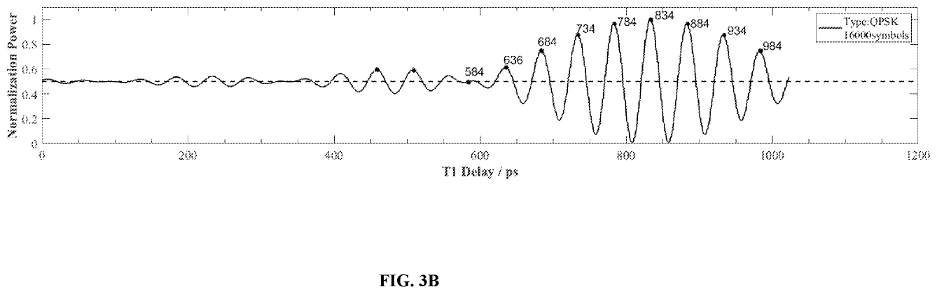

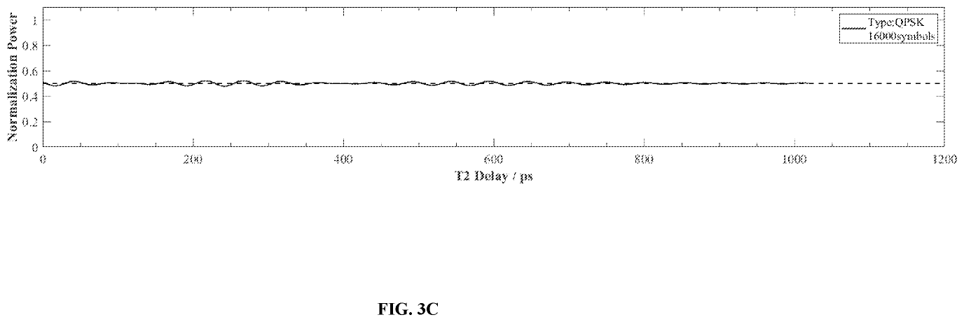

In this embodiment, in order to specify the method of using the device for radar target feature recognition, test results of delay scanning of a single-frequency signal are illustrated. The baseline length L of the two antenna subarray channels is 0.5 m, the target signal is a QPSK signal having carrier frequency of 20 GHz, and bandwidth of 4 GHZ, and the signal arrival angle is 30°, the delay difference between the two channels is about 833.3 ps. As shown in FIG. 3A, it is the spectrum diagram of the received electrical signal. As shown in FIG. 3B, the optical delay of the path T2 is fixed at 0, and the optical delay of the path T1 is scanned in the range of 0-10230 ps. The delay amount of the maximum power peak is 834 ps, and the arrival angle of the signal is arcsin(0.5004)≈30° according to formula (10). As shown in FIG. 3B, the power peak presents the characteristics of periodicity and amplitude attenuation from the center defined by the maximum power peak to both sides. A power peak with a gradually attenuating amplitude occurs at an interval of 50 ps, and the amplitude attenuates to the minimum at an interval of 250 ps. The carrier frequency is 20 GHz according to the power peak delay interval of 50 ps. The signal bandwidth is 4 GHz calculated according to the delay span of the main lobe of the power peak envelope curve of 250 ps. When the bandwidth of the received signal is narrow, the position of the maximum power peak can also be calculated through the second highest power peak, for example, the center of 734 ps and 934 ps is 834 ps.

The above description of the embodiments is for those of ordinary skill in the art to understand and apply the present disclosure. It is apparently that those skilled in the art may make various modifications to the aforementioned embodiments, and apply the general principles described here to other embodiments without creative efforts. Therefore, the present disclosure is not limited to the above embodiments, and improvements and modifications made by those skilled in the art according to this disclosure should fall within the protection scope of the present invention.

What is claimed is:

1. A device for radar target feature recognition based on optical time-delay fast interferometric scanning, comprising:
an antenna unit;
an electro-optical converter;
an optical time-delay numerical control scanning device;
an optical combiner;
a photoelectric detector; and
a power characteristic analysis device;
wherein the antenna unit is configured to receive radar target electrical signals, and the electro-optic converter is configured to convert electrical signal is converted into an optical signal; the optical delay numerical control scanning device is configured to control the delay of the optical signal; the optical combiner is configured for optical signal synthesis; the photodetector is configured to convert the optical signal into a radio frequency signal; and the power characteristic analysis device is configured to calculate the average power of the signal and analysis of radar target features of the radio frequency signal; the optical delay numerical control scanning device comprises a two-path N-stage high-speed optical delay line T1, T2, and an optical delay line controller; the power characteristic analysis device comprises a linear power detector, an analog-to-digital converter, a processor and a memory.

2. The device according to claim 1, wherein the antenna unit comprises a multi-beam reflector antenna, a multi-beam lens antenna and a multi-beam phased array antenna; the antenna unit has a plurality of antenna sub-arrays, each antenna sub-array corresponds to an input channel; the baseline length of adjacent antenna sub-arrays is L, the arrival angle of the signal is θ, the frequency is f, and the wave velocity is c; when adjacent antenna sub-arrays receive the same signal, the delay difference between the two paths is ΔT, the value of which is L sin θ/c, and the phase difference is 2πfΔT.

3. The device according to claim 1, wherein the N-stage high-speed optical delay line is divided into two paths, T1 and T2, which respectively correspond to two input channels of adjacent antenna sub-arrays in the antenna unit; the N-stage high-speed optical delay line includes 2N 1×2 high-speed optical switches; according to the connection mode of 1×2 to 2×1, two high-speed optical switches form a first-stage delay unit, and therefore a total of N-stage delay units is formed; the delay amount of each stage of delay unit is constant, and is twice the delay amount of the previous stage of delay unit; the delay amount of the first-stage delay unit is Δt; the delay amount of the i-th-stage delay unit is 2ⁱ⁻¹×Δt, where i is a value selected from the range of 1-N; the high-speed optical switch includes a magnetic optical switch, an electro-optical switch, a PLZT optical switch.

4. The device according to claim 1, wherein the optical delay line controller is configured to change the delay amount of the N-stage high-speed optical delay line that being divided into the path T1 and the path T2; the optical delay line controller changes the delay amount of the i-th stage delay unit through a 1 bit state: 0 means that the delay amount is 0, and 1 means that the delay amount is 2ⁱ⁻¹×Δt; by controlling N delay units through N bits state, the delay amount of a single-path N-stage high-speed optical delay line can be changed in the range of (0−(2^{N}−1))×Δt, and its resolution is Δt.

5. The device according to claim 1, wherein the optical delay numerical control scanning device realizes forward scanning by fixing the delay amount of the path T2 to 0 and changing the delay amount of the path T1 in the range of (0−(2^{N}−1))×Δt. The reverse scanning is realized by fixing the delay amount of the path T1 to 0 and changing the delay amount of the path T2 in the range of (0−(2^{N}−1))×Δt. The optical time-delay numerical control scanning device changes the time delay within the range of (−(1−2^{N})−(2^{N}−1))×Δt through forward scanning and reverse scanning.

6. The device according to claim 1, wherein different wavelengths λ1 and λ2 are respectively applied in the two paths (T1, T2) of the N-stage high-speed optical delay line; the optical combiner combines the two paths of light into one optical fiber by means of wavelength division multiplexing.

7. The device according to claim 1, wherein the linear power detector is configured to calculate the average power of the radio frequency signal converted by the photodetector; the analog-to-digital converter is configured to quantify the average power obtained by the linear power detector; the memory is configured to store the quantized power value P of the analog-to-digital converter; the processor obtains the characteristics of the radar target according to the variation rule of the power value P with the delay amount; every time the optical delay numerical control scanning device changes the delay amount T_{d} once, the power characteristic analysis device calculates the corresponding power and stores it; when the optical delay numerical control scanning device scans forward and the reverse scanning ends, extracting the power peak value P(Tₖ) and corresponding delay amount Tₖ from the result; and obtaining the characteristic of radar target according to the power peak value P(Tₖ) and the corresponding delay amount Tₖ.

8. The device according to claim 7, wherein when the radar target signal is a single-frequency signal, the period of the single-frequency signal is obtained by a delay amount interval of the power peak (Tₖ₊₁−Tₖ), and the frequency of the single-frequency signal is calculated; the arrival angle θ of the single-frequency signal is calculated by the delay difference ΔT between the two input channels, which is obtained by the delay amount T₀ corresponding to the first power peak value P(T₀).

9. The device according to claim 7, wherein when the radar target signal is a broadband signal, the carrier frequency is obtained by the carrier period of the broadband signal, which is obtained through the delay interval of the power peak (Tₖ₊₁−Tₖ); according to the bandwidth of the broadband signal from the delay span of the main lobe of the envelope curve of the peak value, and the delay difference ΔT between the two input channels according to the delay amount Tᵣ_{₁} corresponding to the center maximum power P(Tᵣ_{₁}), the angle of arrival θ of the wideband signal is obtained.

10. The device according to claim 7, wherein when the radar target signal is a narrowband signal, the delay amount corresponding to the center maximum power is calculated by the delay amount corresponding to two equal power value points on the power peak envelope curve, according to the delay amount Tᵣ_{₁} corresponding to the center maximum power P(Tᵣ_{₁}), the delay difference ΔT of the two input channels is obtained, and the arrival angle θ of the broadband signal is calculated; the carrier frequency is obtained by the carrier period of the broadband signal obtained through the interval of the power peak.
